(19) United States
(12) Patent Application Publication
(10) Pub. No.: US 2014/0229819 A1
(43) Pub. Date: Aug. 14, 2014

(54) DECLARATIVELY RESPONDING TO STATE CHANGES IN AN INTERACTIVE MULTIMEDIA ENVIRONMENT

(71) Applicant: Microsoft Corporation, Redmond, WA (US)

(72) Inventors: Andrew William Jewsbury, Seattle, WA (US); James C. Finger, Kirkland, WA (US); Sean Hayes, Bristol (GB); Jeffrey A. Davis, Snohomish, WA (US)

(21) Appl. No.: 14/258,612

(22) Filed: Apr. 22, 2014

Related U.S. Application Data
(63) Continuation of application No. 11/405,736, filed on Apr. 18, 2006, now abandoned.
(60) Provisional application No. 60/695,944, filed on Jul. 1, 2005.

(51) Int. Cl. G06F 17/22

(52) U.S. Cl. CPC G06F 17/2247
USPC 715/234

(57) ABSTRACT

Using declarative language application instructions, actions associated with playing interactive content of an interactive multimedia presentation are triggered based on a state change of a particular media object. Certain application instructions specify the characteristic of the media object, while other application instructions specify the actions associated with playing the interactive content (for example, when media objects are renderable, event generation, script execution, or changes in variables) based on a state change of the characteristic. The state change is detected by querying a structured representation of the application such as a document object model, which includes nodes associated with the application instructions, the media object, and/or the characteristic. When state changes are detected, one or more of the specified actions are triggered to thereby declaratively respond to the state change. In an illustrative example, the state changes are tracked using attributes which include foreground, focused, pointer, actioned, enabled, and value.

### STATEMENT OF RELATED APPLICATION

This application is a continuation of U.S. Ser. No. 11/405,736 filed Apr. 18, 2006 which claims the benefit of provisional application No. 60/695,944, filed Jul. 1, 2005, which are incorporated by reference herein.

### BACKGROUND

Multimedia players are devices that render combinations of video, audio or data content (“multimedia presentations”) for consumption by users. Multimedia players such as DVD players currently do not provide for much, if any, user interactivity during play of video content—video content play is generally interrupted to receive user inputs other than play speed adjustments. For example, a user of a DVD player must generally stop the movie he is playing to return to a menu that includes options allowing him to select and receive features such as audio commentary, actor biographies, or games.

Interactive multimedia players are devices (such devices may include hardware, software, firmware, or any combination thereof) that render combinations of interactive content concurrently with traditional video, audio or data content (“interactive multimedia presentations”). Although any type of device may be an interactive multimedia player, devices such as optical media players (for example, DVD players), computers, and other electronic devices are particularly well positioned to enable the creation of, and consumer demand for, commercially valuable interactive multimedia presentations because they provide access to large amounts of relatively inexpensive, portable data storage.

Interactive content is generally any user-selectable visible or audible object presentable alone or concurrently with other video, audio or data content. One kind of visible object is a graphical object, such as a circle, that may be used to identify and/or follow certain things within video content—people, cars, or buildings that appear in a movie, for example. One kind of audible object is a click sound played to indicate that the user has selected a visible object, such as the circle, using a device such as a remote control or a mouse. Other examples of interactive content include, but are not limited to, menus, captions, and animations.

To enhance investment in interactive multimedia players and interactive multimedia presentations, it is desirable to ensure accurate synchronization of the interactive content component of interactive multimedia presentations with the traditional video, audio or data content components of such presentations. Accurate synchronization generally prioritizes predictable and glitch-free play of the video, audio or data content components. For example, when a circle is presented around a car in a movie, the movie should generally not pause to wait for the circle to be drawn, and the circle should follow the car as it moves.

Many interactive multimedia environments are currently implemented or planned for implementation on “thin” players, or computing platforms that are purposely resource-constrained in terms of processing power, memory and other resources, often for cost reasons. To efficiently utilize available resources, it can be desirable for applications running on the players to use a declarative approach which often results in simpler and less processor intensive programming.

In a declarative programming paradigm, the semantics required to attain the desired outcome are implicit in the description of the outcome. It is not usually necessary to provide a separate procedure (i.e., write a script or embed executable code) to get the desired outcome. An application author uses declarative programming to generate declarative content which is typically expressed in the form of assertions.

For example, web pages are often considered declarative because they describe what the page should look like—e.g., title, font, text, images—but do not describe how to actually render the graphics and web pages on a computer display. Another application, such as a browser or interactive media player application, takes declarative content to render the graphics to meet the author's objectives.

A declarative approach is in contrast to a procedural approach (also called an “imperative” approach) using traditional languages such as Fortran, C, and Java, which generally require the programmer to specify an algorithm to be run to control or manipulate the interactive media player. Thus, declarative programs make the goal explicit and leave the algorithm implicit, while imperative programs make the algorithm explicit and leave the goal implicit. It is noted that an application need not be purely declarative or purely procedural. Declarative applications often make use of script, which is itself procedural in nature, and a procedural object may be embedded in a declarative application.

Common examples of declarative programming languages include HTML (HyperText Markup Language) and XML (eXtensible Markup Language). These are both markup languages which combine text and information that supplements or describes the text called “tags.” XML is the newer language which is seeing increased use to create graphics, user interfaces, web services (such as electronic shopping and web searches) and other functions because of its extensibility through its support for the user-creation of tags that are described and defined as to their permitted use.

XML thus provides a flexible and straightforward tool for applications to generate interactive experiences for users. However, due to the inherent declarative nature of markup languages, it may presently be difficult for authors to write applications that are able to respond to changes in the interactive multimedia environment. That is, interactive multimedia typically operates in a dynamic environment where states of applications running on the player change as video content progresses and the system (i.e., the player and its applications) receives events such as user inputs. Accordingly, while many interactive multimedia arrangements perform very satisfactorily, it would still be desirable for arrangements using a declarative approach to be able to capture and respond to state changes in the environment while preserving a high degree of resource efficiency.

It will be appreciated that the claimed subject matter is not limited to implementations that solve any or all of the disadvantages of specific interactive multimedia presentation systems or aspects thereof.

### SUMMARY

Using declarative language application instructions, actions associated with playing interactive content of an interactive multimedia presentation are conditionally triggered based on a state change of a particular media object. Media objects include, for example, user-selectable visible or audible objects that are typically presented concurrently with video in the interactive multimedia presentation. Certain declarative application instructions specify the characteristic of the media object, while other declarative application instructions specify the actions associated with playing or rendering the interactive content based on one or more attribute state changes. The state change is detected, in one illustrative example, by querying a structured representation of the application such as a document object model (“DOM”), which includes nodes associated with the application instructions, the media object, and/or the characteristic. When state changes are detected, one or more of the specified actions are triggered to thereby declaratively respond to the state change.

In an illustrative example, content element attributes include those selected from foreground, enabled, focused, actioned, pointer and value which are arranged in a DOM and recursively introspected using an XPATH query. Values associated with these attributes typically change over the course of an interactive media presentation and such values determine how user interactions or events are distributed to applications running in the interactive multimedia presentation.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a simplified functional block diagram of an interactive multimedia presentation system;

FIG. 2 is a graphical illustration of an illustrative presentation timeline, which is ascertainable from the playlist shown in FIG. 1;

FIG. 3 is a simplified functional block diagram of an application associated with the interactive multimedia presentation shown in FIG. 1;

FIG. 4 is a simplified functional block diagram illustrating the timing signal management block of FIG. 1 in more detail;

FIG. 5 is a schematic showing, with respect to a continuous timing signal, the effect of illustrative occurrences on the values of certain time references shown in FIG. 4;

FIG. 6 is a flowchart of a method for using certain application instructions shown in FIG. 3 to play an interactive multimedia presentation;

FIG. 7 is a diagram of a document object model usable in connection with aspects of the method shown in FIG. 6;

FIG. 8 is a simplified functional block diagram of a general-purpose computing unit usable in connection with aspects of the interactive multimedia presentation system shown in FIG. 1;

FIG. 9 is a simplified function block diagram of an illustrative configuration of an operating environment in which the interactive multimedia presentation system shown in FIG. 1 may be implemented or used; and

FIG. 10 is a simplified functional diagram of a client-server architecture in which the interactive multimedia presentation system shown in FIG. 1 may be implemented or used.

### DETAILED DESCRIPTION

In general, an interactive multimedia presentation includes a video content component and an interactive content component. The video content component is referred to as a movie for illustrative purposes, but may in fact be video, audio, data, or any combination thereof.

The interactive content component of the presentation, which is arranged for rendering by an interactive content manager at a rate based on a timing signal, is in the form of one or more applications. An application includes instructions in declarative form (e.g., an XML “markup”) or in script form. The application instructions are provided for organizing, formatting, and synchronizing the presentation of media objects to a user, often concurrently with the video content component. Both the script and markup components of an application may invoke a variety of methods or services through the use of a script API (application programming interface) or markup API, respectively.

Methods, systems, apparatuses, and articles of manufacture discussed herein use application instructions in declarative form to trigger actions associated with playing the interactive content component of an interactive multimedia presentation. Examples of application instructions usable as described above include markup elements and attributes. Characteristics of media objects may be specified by style or non-style attributes of content elements associated with the media objects. Some useful attributes are defined by one or more XML schemas. For example, one or more XML schemas promulgated by the DVD Forum set forth attributes that change values based on user input received during play of an interactive high-definition DVD movie. Actions associated with playing interactive content may further be specified within timing, style and animation elements. Some elements usable in this manner are set forth in XML schemas promulgated by the DVD Forum.

Other elements are defined by XML schemas for Synchronized Multimedia Integration Language (“SMIL”), which are published by the World Wide Web Consortium (“W3C”). XPATH queries may be used to query structured representations of applications such as DOMs to detect values of attributes and changes in such values.

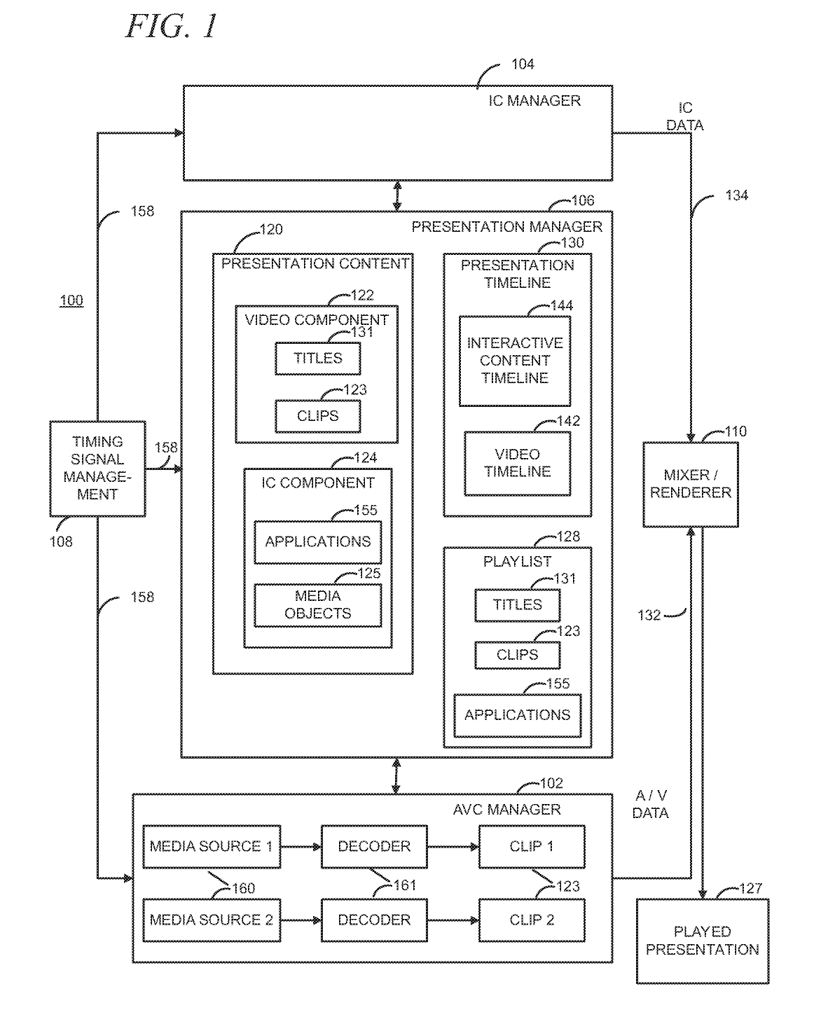

Turning now to the drawings, where like numerals designate like components, FIG. 1 is a simplified functional block diagram of an interactive multimedia presentation system (“Presentation System”) 100. Presentation System 100 includes an audio/video content (“AVC”) manager 102, an interactive content (“IC”) manager 104, a presentation manager 106, a timing signal management block 108, and a mixer/renderer 110. In general, design choices dictate how specific functions of Presentation System 100 are implemented. Such functions may be implemented using hardware, software, or firmware, or combinations thereof.

In operation, Presentation System 100 handles interactive multimedia presentation content (“Presentation Content”) 120. Presentation Content 120 includes a video content component (“video component”) 122 and an interactive content component (“IC component”) 124. Video component 122 and IC component 124 are generally, but need not be, handled as separate data streams, by AVC manager 102 and IC manager 104, respectively.

Presentation System 100 also facilitates presentation of Presentation Content 120 to a user (not shown) as played presentation 127. Played Presentation 127 represents the visible and/or audible information associated with Presentation Content 120 that is produced by mixer/renderer 110 and receivable by the user via devices such as displays or speakers (not shown). For discussion purposes, it is assumed that Presentation Content 120 and played presentation 127 represent high-definition DVD movie content, in any format. It will be appreciated, however, that Presentation Content 120 and Played Presentation 127 may be any type of interactive multimedia presentation now known or later developed.

Video component 122 represents the traditional video, audio or data components of Presentation Content 120. For example, a movie generally has one or more versions (a version for mature audiences, and a version for younger audiences, for example); one or more titles 131 with one or more chapters (not shown) associated with each title (titles are discussed further below, in connection with presentation manager 106); one or more audio tracks (for example, the movie may be played in one or more languages, with or without subtitles); and extra features such as director's commentary, additional footage, trailers, and the like. It will be appreciated that distinctions between titles and chapters are purely logical distinctions. For example, a single perceived media segment could be part of a single title/chapter, or could be made up of multiple titles/chapters. It is up to the content authoring source to determine the applicable logical distinctions. It will also be appreciated that although video component 122 is referred to as a movie, video component 122 may in fact be video, audio, data, or any combination thereof.

Groups of samples of video, audio, or data that form video component 122 are referred to as clips 123 (clips 123 are shown within video component 122, AVC manager 102, and playlist 128). Referring to AVC manager 102, information associated with clips 123 is received from one or more media sources 160 and decoded at decoder blocks 161. A media source is any device, location, or data from which video, audio, or data is derived or obtained. Examples of media sources include, but are not limited to, networks, hard drives, optical media, alternate physical disks, and data structures referencing storage locations of specific video, audio, or data.

Decoder blocks 161 represent any devices, techniques or steps used to retrieve renderable video, audio, or data content from information received from a media source 160. Decoder blocks 161 may include encoder/decoder pairs, demultiplexers, or decrypters, for example. Although a one-to-one relationship between decoders and media sources is shown, it will be appreciated that one decoder may serve multiple media sources, and vice-versa.

Audio/video content data (“A/V data”) 132 is data associated with video component 122 that has been prepared for rendering by AVC manager 102 and transmitted to mixer/renderer 110. Frames of A/V data 134 generally include, for each active clip 123, a rendering of a portion of the clip. The exact portion or amount of the clip rendered in a particular frame may be based on several factors, such as the characteristics of the video, audio, or data content of the clip, or the formats, techniques, or rates used to encode or decode the clip.

Referring again to Presentation Content 120, IC component 124 includes media objects 125, which are user-selectable visible or audible objects, optionally presentable concurrently with video component 122, along with any instructions (shown as applications 155 and discussed further below) for presenting the visible or audible objects. Media objects 125 may be static or animated. Examples of media objects include, among other things, video samples or clips, audio samples or clips, graphics, text, and combinations thereof.

Media objects 125 originate from one or more sources (not shown). A source is any device, location, or data from which media objects are derived or obtained. Examples of sources for media objects 125 include, but are not limited to, networks, hard drives, optical media, alternate physical disks, and data structures referencing storage locations of specific media objects. Examples of formats of media objects 125 include, but are not limited to, portable network graphics (“PNG”), joint photographic experts group (“JPEG”), moving picture experts group (“MPEG”), multiple-image network graphics (“MNG”), audio video interleave (“AVI”), extensible markup language (“XML”), hypertext markup language (“HTML”), extensible HTML (“XHTML”), extensible stylesheet language (“XSL”), and WAV.

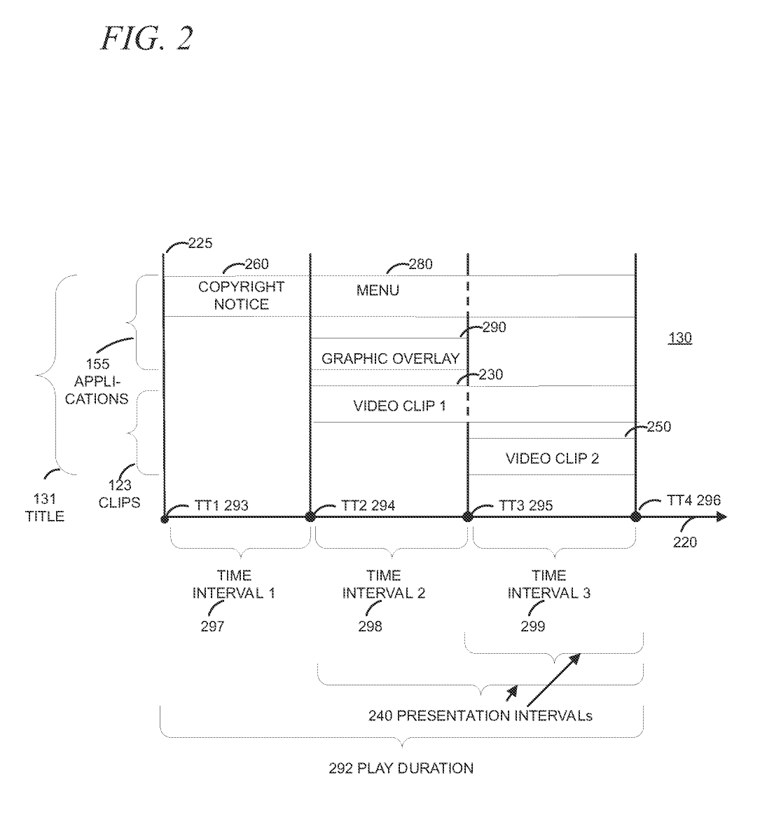

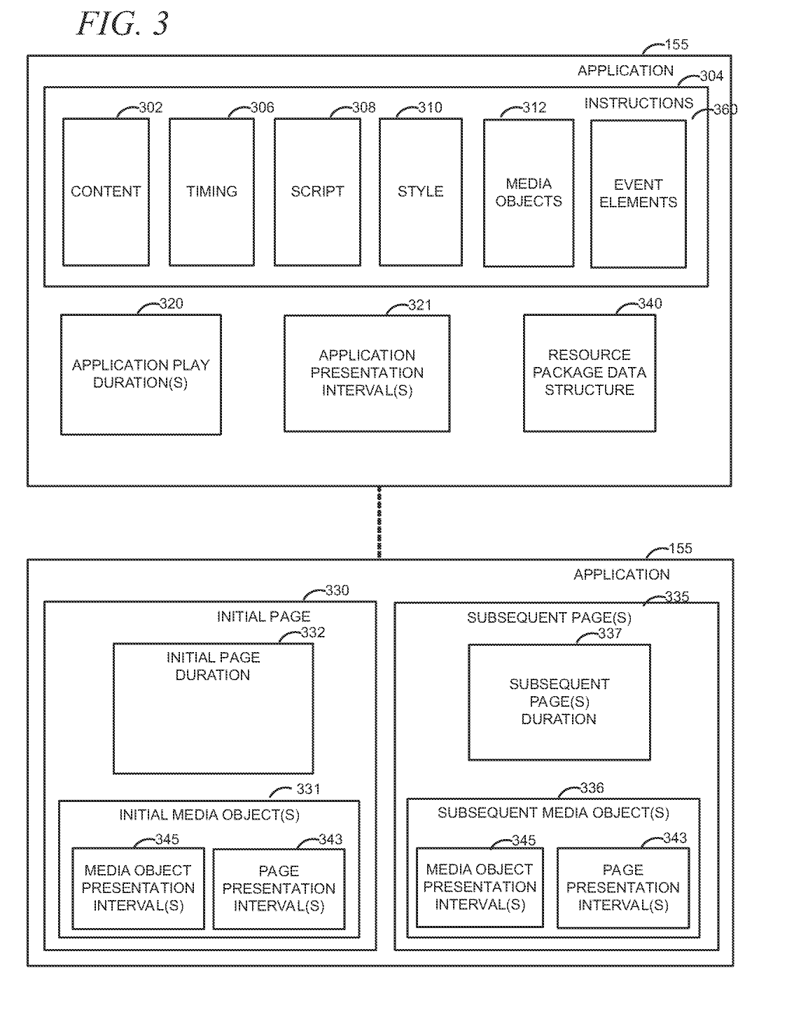

Applications 155 provide the mechanism by which Presentation System 100 presents media objects 125 to a user. Applications 155 represent any signal processing method or stored instruction(s) that electronically control predetermined operations on data. It is assumed for discussion purposes that IC component 124 includes three applications 155, which are discussed further below in connection with FIGS. 2 and 3. The first application presents a copyright notice prior to the movie, the second application presents, concurrently with visual aspects of the movie, certain media objects that provide a menu having multiple user-selectable items, and the third application presents one or more media objects that provide graphic overlays (such as circles) that may be used to identify and/or follow one or items appearing in the movie (a person, a car, a building, or a product, for example).

Interactive content data (“IC data”) 134 is data associated with IC component 124 that has been prepared for rendering by IC manager 104 and transmitted to mixer/renderer 110. Each application has an associated queue (not shown), which holds one or more work items (not shown) associated with rendering the application.

Presentation manager 106, which is configured for communication with both AVC manager 104 and IC manager 102, facilitates handling of Presentation Content 120 and presentation of played presentation 127 to the user. Presentation manager 106 has access to a playlist 128. Playlist 128 includes, among other things, a time-ordered sequence of clips 123 and applications 155 (including media objects 125) that are presentable to a user. The clips 123 and applications 155/media objects 125 may be arranged to form one or more titles 131. For illustrative purposes, one title 131 is discussed herein. Playlist 128 may be implemented using an extensible markup language (“XML”) document, or another data structure.

Presentation manager 106 uses playlist 128 to ascertain a presentation timeline 130 for title 131. Conceptually, presentation timeline 130 indicates the times within title 131 when specific clips 123 and applications 155 are presentable to a user. A sample presentation timeline 130, which illustrates illustrative relationships between presentation of clips 123 and applications 155 is shown and discussed in connection with FIG. 2. In certain circumstances, it is also useful to use playlist 128 and/or presentation timeline 130 to ascertain a video content timeline (“video timeline”) 142 and an interactive content timeline (“IC timeline”) 144.

Presentation manager 106 provides information, including but not limited to information about presentation timeline 130, to AVC manager 102 and IC manager 104. Based on input from presentation manger 206, AVC manager 102 prepares A/V data 132 for rendering, and IC manager 104 prepares IC data 134 for rendering.

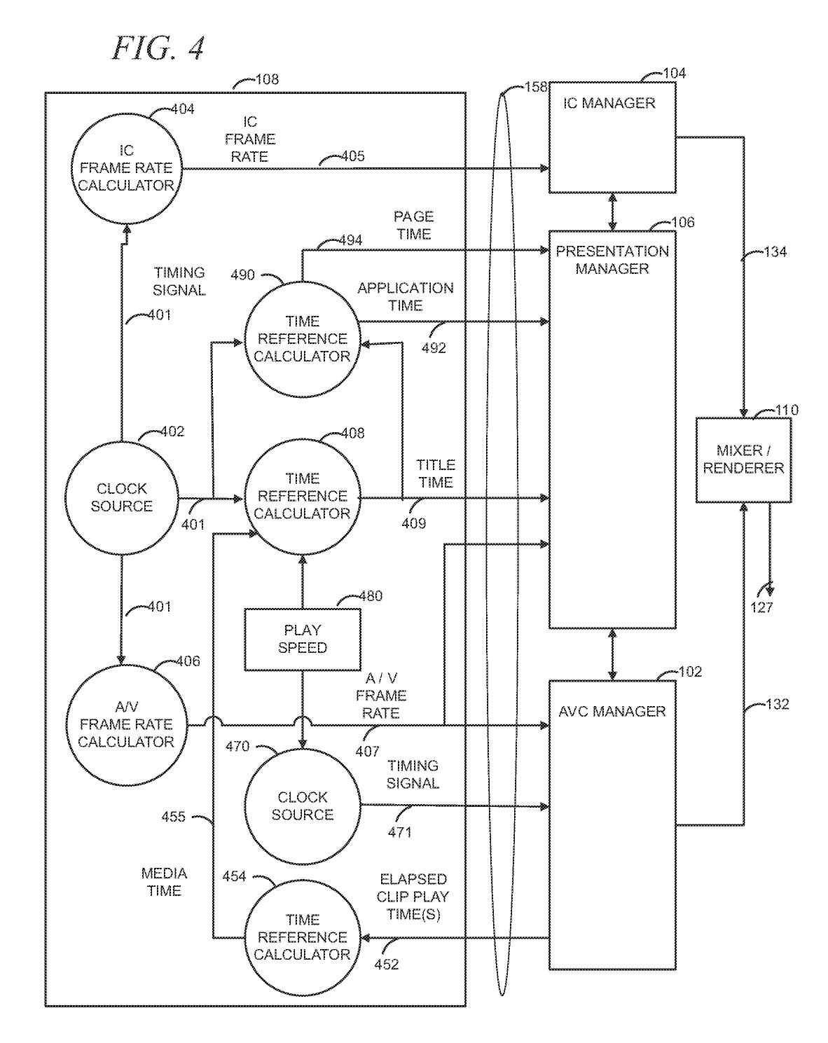

Timing signal management block 108 produces various timing signals 158, which are used to control the timing for preparation and production of A/V data 132 and IC data 134 by AVC manager 102 and IC manager 104, respectively. In particular, timing signals 158 are used to achieve frame-level synchronization of A/V data 132 and IC data 134. Details of timing signal management block 108 and timing signals 158 are discussed further below, in connection with FIG. 4.

Mixer/renderer renders A/V data 132 in a video plane (not shown), and renders IC data 134 in a graphics plane (not shown). The graphics plane is generally, but not necessarily, overlayed onto the video plane to produce played presentation 127 for the user.

With continuing reference to FIG. 1, FIG. 2 is a graphical illustration of a sample presentation timeline 130 for title 131 within playlist 128. Time is shown on horizontal axis 220. Information about video component 122 (clips 123 are illustrated) and IC component 124 (applications 155, which present media objects 125, are illustrated) is shown on vertical axis 225. Regarding video component 122—two clips 123 are shown, a first video clip (“video clip 1”) 230 and a second video clip (“video clip 2”) 250.

Regarding IC component 124, as mentioned above in connection with FIG. 1, a first application is responsible for presenting one or more media objects (for example, images and/or text) that comprise copyright notice 260. A second application is responsible for presenting certain media objects that provide user-selectable items (for example, buttons with associated text or graphics) of menu 280. A third application is responsible for presenting one or more media objects that provide graphic overlay 290. As shown, menu 280 is displayed concurrently with video clip 1 230 and video clip 2 250, and graphic overlay 290 is displayable concurrently with video clip 1 230 and menu 280.

The particular amount of time along horizontal axis 220 in which title 131 is presentable to the user is referred to as play duration 292 of title 131. Specific times within play duration 292 are referred to as title times. Four title times (“TTs”) are shown on presentation timeline 130—TT1 293, TT2 294, TT3 295, and TT4 296. Because a title may be played once or may be played more than once (in a looping fashion, for example) play duration 292 is determined based on one iteration of title 131. Play duration 292 may be determined with respect to any desired reference, including but not limited to a predetermined play speed (for example, normal, or 1×, play speed), a predetermined frame rate, or a predetermined timing signal status. Play speeds, frame rates, and timing signals are discussed further below, in connection with FIG. 4.

It will be appreciated that implementation-specific factors such as display techniques and specific rules regarding play sequences and timing relationships among clips and media objects for each title may impact upon exact values of a title's play duration and title times therein. The terms play duration and title times are intended to encompass all such implementation-specific details.

Although title times at/within which content associated with IC component 124 is presentable are generally predetermined, it will be appreciated that actions taken when the user interacts with such content may only be determined based on user input while Played Presentation 127 is playing. For example, the user may select, activate, or deactivate certain applications, media objects, and/or additional content associated therewith during play of Played Presentation 127.

Other times and/or durations within play duration 292 are also defined and discussed herein. Video presentation intervals 240 are defined by beginning and ending times of play duration 292 between which particular content associated with video component 122 is playable. For example, video clip 1 230 has a presentation interval 240 between title times TT2 294 and TT4 296, and video clip 2 250 has a presentation interval 240 between title times TT3 295 and TT4 296. Application presentation intervals, application play durations, page presentation intervals, and page durations are also defined and discussed below, in connection with FIG. 3.

With continuing reference to FIGS. 1 and 2, FIG. 3 is a functional block diagram of a single application 155. Application 155 is generally representative of applications responsible for presenting media objects 260, 280, and 290 (shown in FIG. 2). Application 155 includes instructions 304 (discussed further below), including content instructions 302, timing instructions 306, script instructions 308, style instructions 310, media object instructions 312, and event instructions 360. Application 155 has associated therewith zero or more resource package data structures 340 (discussed further below), an application play duration 320, and one or more application presentation intervals 321.

Application play duration 320 is a particular amount of time, with reference to an amount (a part or all) of play duration 292 within which media objects 125 associated with application 155 are presentable to and/or selectable by a recipient of played presentation 127. In the context of FIG. 2, for example, application 155 responsible for copyright notice 260 has an application play duration composed of the amount of time between TT1 293 and TT2 294. The application responsible for menu 280 has an application play duration composed of the amount of time between TT2 294 and TT4 296. The application responsible for graphical overlay 290 has an application play duration composed of the amount of time between TT2 294 and TT3 295.

The intervals defined by beginning and ending title times obtained when an application play duration 320 associated with a particular application is conceptualized on presentation timeline are referred to as application presentation intervals 321. For example, referring to FIG. 2, the application responsible for copyright notice 260 has an application presentation interval beginning at TT1 293 and ending at TT2 294, the application responsible for menu 280 has an application presentation interval beginning at TT2 294 and TT4 296, and the application responsible for graphic overlay 290 has an application presentation interval beginning at TT2 294 and ending at TT3 295.

Referring again to FIG. 3, in some cases, application 155 may have more than one page. A page is a logical grouping of one or more media objects that are contemporaneously presentable within a particular application play duration 320 and/or application presentation interval 321. An initial page 330 and subsequent page(s) 335 are shown. Each page, in turn, has its own page duration. A page duration is the particular amount of time, with reference to an amount (a part or all) of application play duration 320, in which media objects associated with a particular page are presentable to (and/or selectable by) a user. As shown, initial page 330 has page duration 332, and subsequent page(s) 335 has page duration 337.

Media objects associated with a particular page may be presented concurrently, serially, or a combination thereof. As shown, initial page 330 has associated initial media object(s) 331, and subsequent pages 335 have associated media object(s) 336. The intervals defined by beginning and ending title times obtained when a page duration associated with a particular page is conceptualized on the presentation timeline (see FIG. 2) are referred to as page presentation intervals 343. Page presentation intervals 343 are sub-intervals of application presentation intervals 321 within which specific media objects 331, 336 are presentable. Specific media object presentation intervals 345 may also be defined within page presentation intervals 343.

The number of applications and pages associated with a given title, and the media objects associated with each application or page, are generally logical distinctions that are matters of design choice. For example, designation of a particular initial page is not necessary, more than one page of an application may be presented concurrently, or an application may be started with no pages (or an initial page that contains nothing). Pages of an application may be loaded and unloaded while keeping the application and script intact. Multiple pages may be used when it is desirable to manage (for example, limit) the number or amount of resources associated with an application that are loaded into memory during execution of the application. Resources for an application include the media objects used by the application, as well as instructions 304 for rendering the media objects. For example, when an application with multiple pages is presentable, it may be possible to only load into memory only those resources associated with a currently presentable page of the application.

Resource package data structure 340 is used to facilitate loading of application resources into memory (optionally, prior to execution of the application). Resource package data structure 340 references memory locations where resources for that application are located. Resource package data structure 340 may be stored in any desirable location, together with or separate from the resources it references. For example, resource package data structure 340 may be disposed on an optical medium such as a high-definition DVD, in an area separate from video component 122. Alternatively, resource package data structure 340 may be embedded into video component 122. In a further alternative, the resource package data structure may be remotely located. One example of a remote location is a networked server. Topics relating to handling the transition of resources for application execution, and between applications, are not discussed in detail herein.

Referring again to application 155 itself, instructions 304, when executed, perform tasks related to rendering of media objects 125 associated with application 155, based on user input. One type of user input (or a result thereof) is a user event. User events are actions or occurrences initiated by a recipient of played presentation 127 that relate to IC component 124. User events are generally, but not necessarily, asynchronous. Examples of user events include, but are not limited to, user interaction with media objects within played presentation 127, such as selection of a button within menu 280, or selection of the circle associated with graphical overlay 290. Such interactions may occur using any type of user input device now known or later developed, including a keyboard, a remote control, a mouse, a stylus, or a voice command. It will be appreciated that application 155 may respond to events other than user events, such as system events, document object model events, or other types of events.

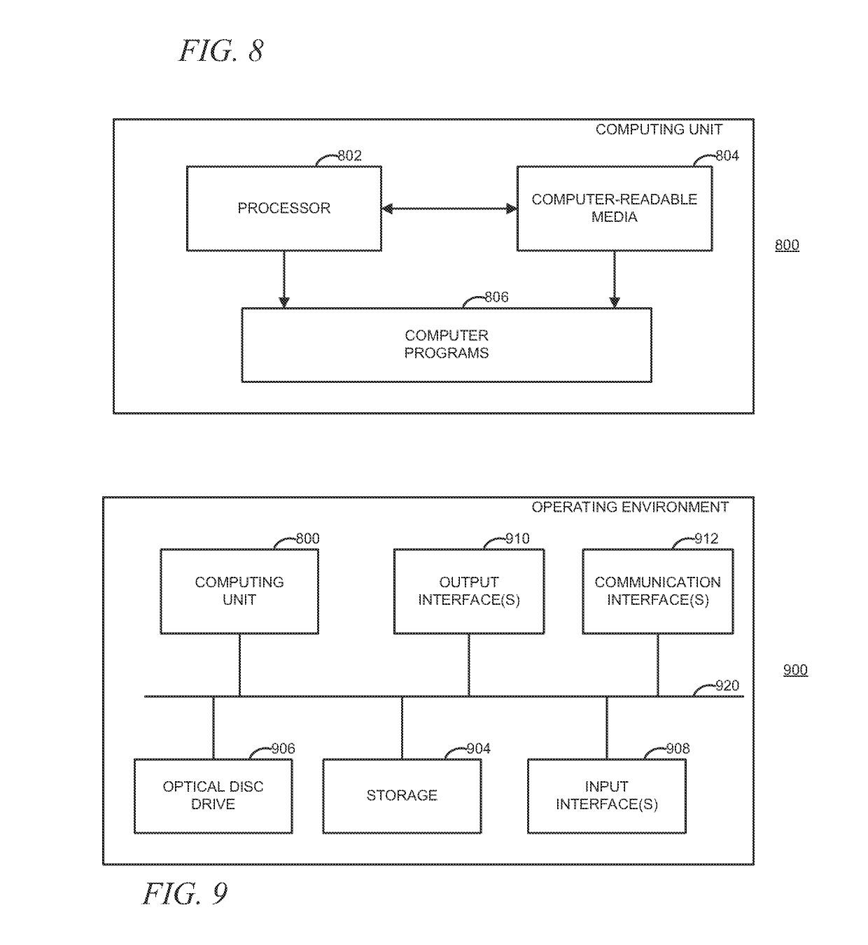

In one implementation, instructions 304 are computer-executable instructions encoded in computer-readable media (discussed further below, in connection with FIGS. 8 and 9). In the examples set forth herein, instructions 304 are implemented using either script 308 or markup elements 302, 306, 310, 312, 360. Although either script or markup elements may be used alone, in general, the combination of script and markup elements enables the creation of a comprehensive set of interactive capabilities for a high-definition DVD movie.

Script 308 includes instructions 304 written in a non-declarative programming language, such as an imperative programming language. An imperative programming language describes computation in terms of a sequence of commands to be performed by a processor. In most cases where script 308 is used, the script is used to respond to user events. Script 308 is useful in other contexts, however, such as handling issues that are not readily or efficiently implemented using markup elements alone. Examples of such contexts include system events, state management, and resource management (for example, accessing cached or persistently stored resources). In one implementation, script 308 is ECMAScript as defined by ECMA International in the ECMA-262 specification. Common scripting programming languages falling under ECMA-262 include JavaScript and JScript. In some settings, it may be desirable to implement 308 using a subset of ECMAScript 262, such as ECMA-327.

Markup elements 302, 306, 310, 312, and 360 represent instructions 304 written in a declarative programming language, such as Extensible Markup Language (“XML”). In XML, elements are logical units of information defined, using start-tags and end-tags, within XML documents. XML documents are data objects that are made up of storage units called entities (also called containers), which contain either parsed or unparsed data. Parsed data is made up of characters, some of which form character data, and some of which form markup. Markup encodes a description of the document's storage layout and logical structure. There is one root element in an XML document, no part of which appears in the content of any other element. For all other elements, the start-tags and end-tags are within the content of other elements, nested within each other.

An XML schema is a definition of the syntax(es) of a class of XML documents. Some XML schemas are defined by the World Wide Web Consortium (“W3C”). Other XML schemas have been promulgated by the DVD Forum for use with XML documents in compliance with the DVD Specifications for High Definition Video, and for other uses. It will be appreciated that other schemas for high-definition DVD movies, as well as schemas for other interactive multimedia presentations, are possible.

At a high level, an XML schema includes: (1) a global element declaration, which associates an element name with an element type, and (2) a type definition, which defines attributes, sub-elements, and character data for elements of that type. Attributes of an element specify particular properties of the element, such as style properties and state properties as described below, using a name/value pair, with one attribute specifying a single element property.

Content elements 302, which may include event elements 360, are used to identify particular media object elements 312 presentable to a user by application 155. Media object elements 312, in turn, generally specify locations where data defining particular media objects 125 is disposed. Such locations may be, for example, locations in local or remote storage, including locations on optical media, or on wired or wireless, public or private networks, such as on the Internet, privately managed networks, or the World Wide Web. Locations specified by media object elements 312 may also be references to locations, such as references to resource package data structure 340. In this manner, locations of media objects 125 may be specified indirectly.

Timing elements 306 are used to specify the times at, or the time intervals during, which particular content elements 302 are presentable to a user by a particular application 155. Examples of timing elements include par, timing, or seq elements within a time container of an XML document. Some timing elements are defined by standards published by the W3C for Synchronized Multimedia Integration Language (“SMIL”). Other timing elements are defined by standards published by the DVD Forum (for example, DVD Specifications for High Definition Video). The standards are incorporated by reference herein for all purposes. Different timing elements associated with other timing models for use with declarative language documents are also possible.

Style elements 310 (and corresponding style attributes) are generally used to specify the appearance of particular content elements 302 presentable to a user by a particular application. Certain style elements are defined by the W3C and/or by the DVD Forum in one or more published specifications. Examples of specifications published by the W3C include specifications relating to XSL and specifications relating to cascading style sheets (“CSS”).

Event elements 360 are elements with a user-specified name and a variable set of user defined parameters that are usable for identifying the occurrence of a particular condition during playback of the markup DOM. In one illustrative example, event elements are only consumable by script. Thus, event elements are declarative elements that are contained within the construct of a timing element (e.g., timing elements 306) used to notify script (e.g., script 308) of any type of condition that can be described by its syntax. Event tags may be derived from or be similar to event tags specified by the W3C, or they may be different from event tags specified by the W3C.

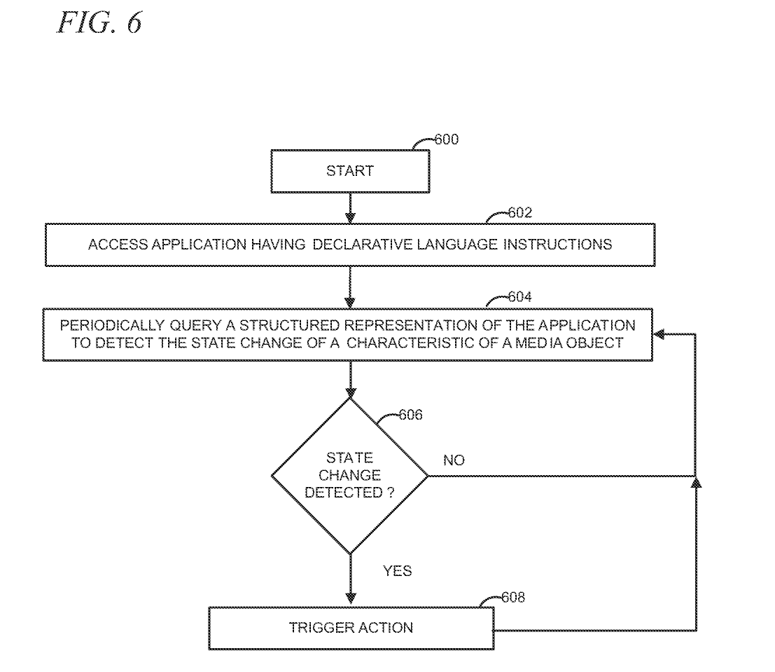

Markup elements 302, 306, 310, and 360 have attributes that are usable to specify certain properties of their associated media object elements 312/media objects 125 to thereby both synchronize the rendering of the markup elements and to coordinate the activation of events declared in the markup. In one illustrative implementation, these attributes/properties represent values of one or more clocks or timing signals (discussed further below, in connection with FIG. 4). Using attributes of markup elements that have properties representing times or time durations is particular one way (i.e., using an inline timing construct) where synchronization between IC component 124 and video component 122 is achieved while a user receives played presentation 127. However, it is emphasized that timing attributes are not limited in application to markup elements only and may be generally applied to the eventing system described herein as a whole (e.g., Presentation System 100). In another illustrative implementation (discussed further below in connection with FIG. 6), structured representations of these attributes/properties are periodically queried, and particular values or changes therein are usable to trigger one or more actions associated with playing IC component 124 within played presentation 127.

A sample XML document containing markup elements is set forth below (script 308 is not shown). The sample XML document includes style 310 and timing 306 elements for performing a crop animation on a content element 302, which references a media object element 312 called “id.” The location of data defining media object 125 associated with the “id” media object element is not shown. It will be appreciated that the sample XML document below is provided for illustrative purposes, and may not be syntactically legal.

The sample XML document begins with a root element called “root.” Following the root element, several namespace “xmlns” fields refer to locations on the World Wide Web where various schemas defining the syntax for the sample XML document, and containers therein, can be found. In the context of an XML document for use with a high-definition DVD movie, for example, the namespace fields may refer to websites associated with the DVD Forum.

One content element 302 referred to as “id” is defined within a container described by tags labeled “body.” Style elements 310 (elements under the label “styling” in the example) associated with content element “id” are defined within a container described by tags labeled “head.” Timing elements 306 (elements under the label “timing”) are also defined within the container described by tags labeled “head.”

```
- <root xml:lang=″en″ xmlns=″http://www.dvdforum.org/2005/ihd″
xmlns:style=″http://www.dvdforum.org/2005/ihd#style″
xmlns:state=″http://www.dvdforum.org/2005/ihd#state”
- <head> (Head is the container of style and timing properties)
  - <styling> (Styling Properties are here)
    <style id=″s-p″ style:fontSize=″10px″ />
    <style id=″s-bosbkg″ style:opacity=″0.4″
    style:backgroundImage=″url(′../../img/pass/boston.png′)″ />
    <style id=″s-div4″ style=″s-bosbkg″ style:width=″100px″
    style:height=″200px″ />
    <style id=″s-div5″ style:crop=″0 0 100 100″ style=″s-bosbkg″
    style:width=″200px″ style:height=″100px″ />
    <style id=″s-div6″ style:crop=″100 50 200 150″ style=″s-bosbkg″
    style:width=″100px″ style:height=″100px″ />
  </styling>
  - <Timing> (Timing Properties are here)
    - <timing clock=″title″>
    - <defs>
    - <g id=″xcrop″>
      <set style:opacity=″1.0″ />
      <animate style:crop=″0 0 100 200;200 0 300 200″ />
    </g>
    - <g id=″ycrop″>
      <set style:opacity=″1.0″ />
      <animate style:crop=″0 0 100 100;0 100 100 200″ />
    </g>
    - <g id=″zoom″>
      <set style:opacity=″1.0″ />
      <animate style:crop=″100 50 200 150;125 75 150 100″ />
    </g>
    </defs>
    - <seq>
      <cue use=″xcrop″ select=″//div[@id=′d4′]″ dur=″3s″ />
      <cue use=″ycrop″ select=″//div[@id=′d5′]″ dur=″3s″ />
      <cue use=″zoom″ select=″//div[@id=′d6′]″ dur=″3s″ />
    </seq>
  </timing>
</head>
  - <body state:foreground=″true″> Body is the container for content
    elements
    - <div id=″d1″> The content starts here.
    - <p style:textAlign=″center″>
    Crop Animation Test
    <br />
    <span style:fontSize=″12px″>Start title clock to animate crop.</span>
    </p>
    </div>
    <div id=″d4″ style=″s-div4″ style:position=″absolute″
    style:x=″10%″ style:y=″40%″>
      <p style=″s-p″>x: 0 -> 200</p>
    </div>
    - <div id=″d5″ style=″s-div5″ style:position=″absolute″ style:x=″30%″
    style:y=″40%″>
    <p style=″s-p″>y: 0 -> 100</p>
    </div>
    - <div id=″d6″ style=″s-div6″ style:position=″absolute″
    style:x=″70%″ style:y=″60%″>
    - <p style=″s-p″>
    x: 100 -> 125
    <br />
    y: 50 -> 75
    </p>
    </div>
  </body>
</root>
```

With continuing reference to FIGS. 1-3, FIG. 4 is a simplified functional block diagram illustrating various components of timing signal management block 108 and timing signals 158 in more detail.

Timing signal management block 108 is responsible for the handling of clocks and/or timing signals that are used to determine specific times or time durations within Presentation System 100. As shown, a continuous timing signal 401 is produced at a predetermined rate by a clock source 402. Clock source 402 may be a clock associated with a processing system, such as a general-purpose computer or a special-purpose electronic device. Timing signal 401 produced by clock source 402 generally changes continually as a real-world clock would—within one second of real time, clock source 402 produces, at a predetermined rate, one second worth of timing signals 401. Timing signal 401 is input to IC frame rate calculator 404, A/V frame rate calculator 406, time reference calculator 408, and time reference calculator 490.

IC frame rate calculator 404 produces a timing signal 405 based on timing signal 401. Timing signal 405 is referred to as an “IC frame rate,” which represents the rate at which frames of IC data 134 are produced by IC manager 104. One illustrative value of the IC frame rate is 30 frames per second. IC frame rate calculator 404 may reduce or increase the rate of timing signal 401 to produce timing signal 405.

Frames of IC data 134 generally include, for each valid application 155 and/or page thereof, a rendering of each media object 125 associated with the valid application and/or page in accordance with relevant user events. For illustrative purposes, a valid application is one that has an application presentation interval 321 within which the current title time of play duration 292 falls, based on presentation timeline 130. It will be appreciated that an application may have more than one application presentation interval. It will also be appreciated that no specific distinctions are made herein about an application's state based on user input or resource availability.

A/V frame rate calculator 406 also produces a timing signal—timing signal 407—based on timing signal 401. Timing signal 407 is referred to as an “A/V frame rate,” which represents the rate at which frames of A/V data 132 are produced by AVC manager 102. The A/V frame rate may be the same as, or different from, IC frame rate 405. One illustrative value of the A/V frame rate is 24 frames per second. A/V frame rate calculator 406 may reduce or increase the rate of timing signal 401 to produce timing signal 407.

A clock source 470 produces timing signal 471, which governs the rate at which information associated with clips 123 is produced from media source(s) 161. Clock source 470 may be the same clock as clock 402, or based on the same clock as clock source 402. Alternatively, clocks 470 and 402 may be altogether different, and/or have different sources. Clock source 470 adjusts the rate of timing signal 471 based on a play speed input 480. Play speed input 480 represents user input received that affects the play speed of played presentation 127. Play speed is affected, for example, when a user jumps from one part of the movie to another (referred to as “trick play”), or when the user pauses, slow-forwards, fast-forwards or slow-reverses, or fast-reverses the movie. Trick play may be achieved by making selections from menu 280 (shown in FIG. 2) or in other manners.

Time references 452 represent the amounts of time that have elapsed within particular presentation intervals 240 associated with active clips 123. For purposes of discussion herein, an active clip is one that has a presentation interval 240 within which the current title time of play duration 292 falls, based on presentation timeline 130. Time references 452 are referred to as “elapsed clip play time(s).” Time reference calculator 454 receives time references 452 and produces a media time reference 455. Media time reference 455 represents the total amount of play duration 292 that has elapsed based on one or more time references 452. In general, when two or more clips are playing concurrently, only one time reference 452 is used to produce media time reference 455. The particular clip used to determine media time reference 455, and how media time reference 455 is determined based on multiple clips, is a matter of implementation preference.

Time reference calculator 408 receives timing signal 401, media time reference 455, and play speed input 480, and produces a title time reference 409. Title time reference 409 represents the total amount of time that has elapsed within play duration 292 based on one or more of the inputs to time reference calculator 408.

Time reference calculator 490 receives timing signal 401 and title time reference 409, and produces application time reference(s) 492 and page time reference(s) 494. A single application time reference 492 represents an amount of elapsed time of a particular application play duration 320 (shown and discussed in connection with FIG. 3), with reference to continuous timing signal 401. Application time reference 492 is determined when title time reference 409 indicates that the current title time falls within application presentation interval 321 of the particular application. Application time reference 492 re-sets (for example, becomes inactive or starts over) at the completion of application presentation interval 321. Application time reference 492 may also re-set in other circumstances, such as in response to user events, or when trick play occurs.

Page time reference 494 represents an amount of elapsed time of a single page play duration 332, 337 (also shown and discussed in connection with FIG. 3), with reference to continuous timing signal 401. Page time reference 494 for a particular page of an application is determined when title time reference 409 indicates that the current title time falls within an applicable page presentation interval 343. Page presentation intervals are sub-intervals of application presentation intervals 321. Page time reference(s) 494 may re-set at the completion of the applicable page presentation interval(s) 343. Page time reference 494 may also re-set in other circumstances, such as in response to user events, or when trick play occurs. It will be appreciated that media object presentation intervals 345, which may be sub-intervals of application presentation intervals 321 and/or page presentation intervals 343, are also definable.

Table 1 illustrates illustrative occurrences during play of played presentation 127 by Presentation System 100, and the effects of such occurrences on application time reference 492, page time reference 494, title time reference 409, and media time reference 455.

TABLE 1

| | Application | Page Time | Title Time | Media Time |
|---|---|---|---|---|
| Occurrence | Time 492 | 494 | 409 | 455 |
| Movie | Inactive | Inactive | Starts | Starts |
| starts | unless/until | unless/until | (e.g., at zero) | (e.g., at zero) |
| | application | applicable | | |
| | is valid | page is | | |
| | | valid | | |
| Next clip | Inactive | Inactive | Determined | Re-sets/ |
| starts | unless/until | unless/until | based on | re-starts |
| | application | applicable | previous title | |
| | is valid | page is | time and | |
| | | valid | elapsed clip | |
| | | | play time | |
| Next title | Inactive | Inactive | Re-sets/ | Re-sets/ |
| starts | unless/until | unless/until | re-starts | re-starts |
| | application | applicable | | |
| | is valid | page is | | |
| | | valid | | |
| Application | Starts | Starts when | Continues/ | Continues/ |
| becomes | | applicable | no effect | no effect |
| valid | | page is | | |
| | | valid | | |
| Trick Play | Re-sets/ | Re-sets/ | Based on | Advances |
| | re-starts if | re-starts if | jumped-to | or retreats |
| | applicable | applicable | location, | to time |
| | application | page is | advances or | corresponding |
| | is valid at | valid at the | retreats to time | to |
| | the title time | title time | corresponding | elapsed clip |
| | jumped to; | jumped to; | to elapsed play | play time(s) |
| | otherwise | otherwise | duration on | of active |
| | becomes | becomes | presentation | clip(s) at the |
| | inactive | inactive | timeline | jumped-to |
| | | | | location |
| | | | | within |
| | | | | the title |
| Change | Continues/ | Continues/ | Elapses N | Elapses N |
| play speed | no effect | no effect | times faster | times faster |
| times N | | | | |
| Movie | Continues/ | Continues/ | Pauses | Pauses |
| pauses | no effect | no effect | | |
| Movie | Continues/ | Continues/ | Resumes | Resumes |
| resumes | no effect | no effect | | |

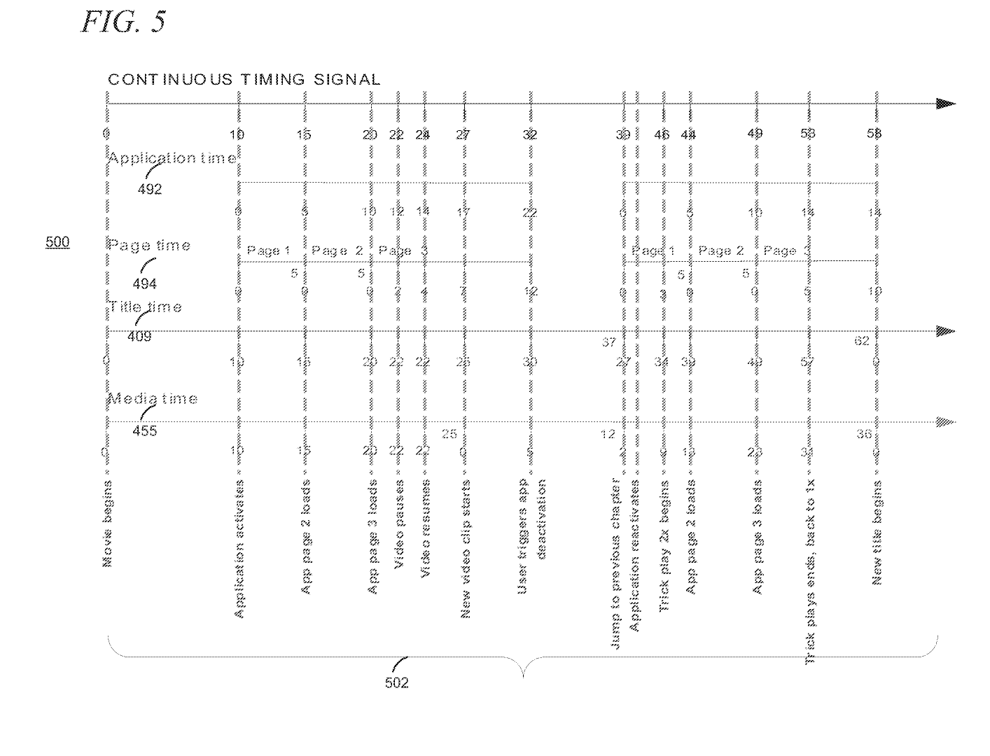

FIG. 5 is a schematic, which shows in more detail the effects of certain occurrences 502 during play of played presentation 127 on application time reference 492, page time reference(s) 494, title time reference 409, and media time reference 455. Occurrences 502 and effects thereof are shown with respect to values of a continuous timing signal, such as timing signal 401. Unless otherwise indicated, a particular title of a high-definition DVD movie is playing at normal speed, and a single application having three serially presentable pages provides user interactivity.

The movie begins playing when the timing signal has a value of zero. When the timing signal has a value of 10, the application becomes valid and activates. Application time 492, as well as page time 494 associated with page one of the application, assumes a value of zero. Pages two and three are inactive. Title time 409 and media time 455 both have values of 10.

Page two of the application loads at timing signal value 15. The application time and page one time have values of 5, while the title time and the media time have values of 15.

Page three of the application loads when the timing signal has a value of 20. The application time has a value of 10, page two time has a value of 5, and page one time is inactive. The title time and the media time have values of 20.

The movie pauses at timing signal value 22. The application time has a value of 12, page three time has a value of two, and pages one and two are inactive. The title time and media time have values of 22. The movie resumes at timing signal value 24. Then, the application time has a value of 14, page three time has a value of four, and the title time and media time have values of 22.

At timing signal value 27, a new clip starts. The application time has a value of 17, page three time has a value of 7, the title time has a value of 25, and the media time is re-set to zero.

A user de-activates the application at timing signal value 32. The application time has a value of 22, the page time has a value of 12, the title time has a value of 30, and the media time has a value of 5.

At timing signal value 39, the user jumps, backwards, to another portion of the same clip. The application is assumed to be valid at the jumped-to location, and re-activates shortly thereafter. The application time has a value of 0, page one time has a value of zero, the other pages are inactive, the title time has a value of 27, and the media time has a value of 2.

At timing signal value 46, the user changes the play speed of the movie, fast-forwarding at two times the normal speed. Fast-forwarding continues until timing signal value 53. As shown, the application and page times continue to change at a constant pace with the continuous timing signal, unaffected by the change in play speed of the movie, while the title and media times change in proportion to the play speed of the movie. It should be noted that when a particular page of the application is loaded is tied to title time 409 and/or media time 455 (see discussion of application presentation interval(s) 321 and page presentation interval(s) 343, in connection with FIG. 3).

At timing signal value 48, a new title begins, and title time 409 and media time 455 are re-set to values of zero. With respect to the initial title, this occurs when the title time has a value of 62, and the media time has a value of 36. Re-setting (not shown) of application time 492 and page time 494 follows re-setting of title time 409 and media time 455.

Having access to various timelines, clock sources, timing signals, and timing signal references enhances the ability of Presentation System 100 to achieve frame-level synchronization of IC data 124 and A/V data 132 within played presentation 127, and to maintain such frame-level synchronization during periods of user interactivity.

With continuing reference to FIGS. 1-4, FIG. 6 is a flowchart of one method for enhancing the ability of an interactive multimedia presentation system, such as Presentation System 100, to synchronously present interactive and video components of an interactive multimedia presentation, such as IC component 124 and video component 122 of Presentation Content 120/played presentation 127. The method involves using certain application instructions in declarative form to conditionally trigger certain actions associated with playing IC component 124. The actions are triggered based on states of one or more characteristics of one or more media objects during play of the interactive multimedia presentation (based on user input, for example).

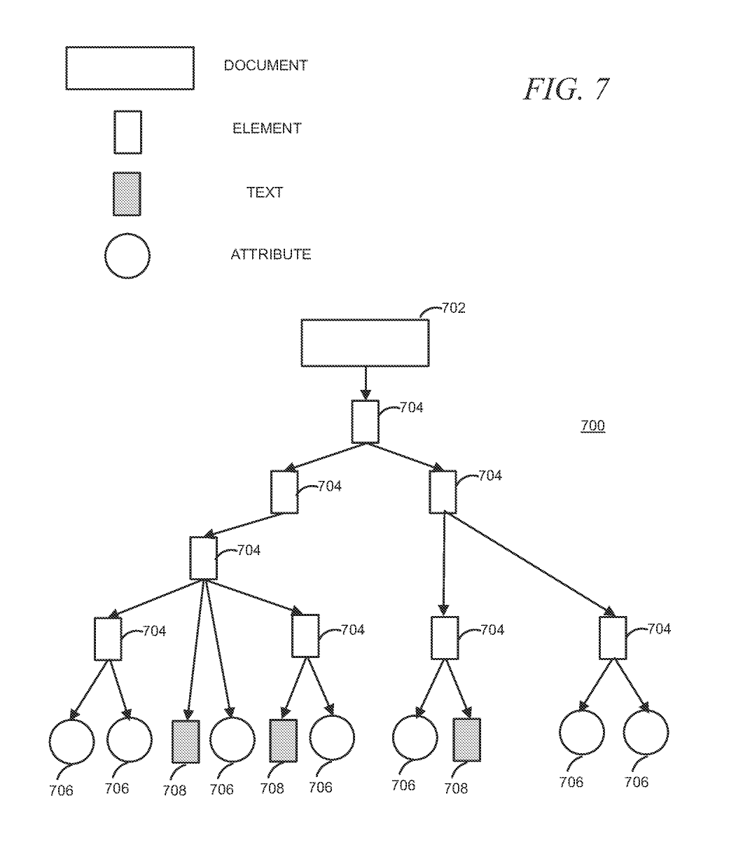

FIG. 6 shows one particular illustrative method for declaratively responding to state changes within the interactive multimedia environment in which a structured representation of an application (such as a DOM as shown in FIG. 7 and described in the accompanying text) is periodically accessed using an XPATH query to detect and then trigger responses to changes in state in the environment. In addition to this declarative method, a programmatic (i.e., imperative) event driven method is alternatively utilized. For example, other objects in the environment may be structured to respond to particular changes in state. A programmed construct enables state attributes to inform such objects of the state change to thereby trigger the response. Thus, in addition to periodically querying the DOM to detect state changes (a form of polling), affirmative event notification may be utilized depending on specific requirements and implemented, for example, by passing the object's event handler to a suitable notification method using script, a markup API or script API. The state change is then signaled when the state attribute changes.

The method begins at block 600, and continues at block 602, where an application having declarative language instructions is accessed. Certain declarative instructions specify characteristics of media objects. Other declarative instructions specify actions associated with playing or rendering interactive content of the presentation based on state changes of the characteristics. During play of the interactive multimedia presentation, the characteristics will typically take on a variety of different states. That is, as one or more interactive applications load and run (for example, to create an interactive menu or provide other interactive content to a user) a variety of states defined by content element attributes (as described below) typically change to reflect the changing interactive environment,

At block 604, a structured representation of the application, such as a DOM as shown in FIG. 7 below, is periodically queried to detect the state changes. When a relevant state change is detected, as determined at diamond 606, the actions specified by the declarative instruction are triggered at block 608, and the periodic querying at block 604 continues. If the relevant state change is not detected at diamond 606, the periodic querying at block 604 continues.

Referring to block 602, application instructions 304 (shown in FIG. 3), such as content elements 302, style elements 310, media object elements 312, or event elements 360 and attributes thereof serve to specify particular media objects 125 and associated characteristic states (for example, values of attributes) that may be assumed during play of played presentation 127. Certain attributes for use with markup elements appearing in high-definition DVD movie applications are defined by one or more XML schemas promulgated by the DVD Forum. In an illustrative example, attributes include style and state attributes.

Certain attributes may be defined with respect to user events. One type of user event that may affect the value of a style attribute or a state attribute is a gesture event. A gesture event is any user-initiated action (such as an input from a device such as a keyboard, remote control, or mouse) that affects presentation of a media object within played presentation 127. Values of characteristic states and attributes in general, and of style or state attributes in particular, can assume alternate, or binary, states. Examples of such alternate or binary states include true or false, on or off, zero or one, and the like. Alternatively, values of characteristic states and attributes can assume general values, such as string values or numeric values. In a further alternative, values of characteristic states and attributes can assume values within pre-defined sets, such as values representing particular colors within a pre-defined set of colors.

Referring again to block 602, within application instructions 304 (shown in FIG. 3) one or more actions associated with playing IC component 124 that may be triggered based on changes in characteristic states are specified using other declarative instructions. Examples of such actions include content rendering, event generation, script execution, changes in variable values, and other actions. Within an application or pages thereof, multiple timing elements may be used, and the timing elements may be synchronized to the same or different clocks. For example, timing signals 401 and 471 may be referred to directly or indirectly to establish clocks to which the timing elements are synchronized. For example, timing signal 401 may be referred to indirectly via clock source 402, IC frame rate calculator 404, A/V frame rate calculator 406, application time 492, or page time 494. Likewise, timing signal 471 may be referred to indirectly via clock source 470, elapsed clip play time(s) 452, time reference calculator 454, media time reference 455, time reference calculator 408, or title time reference 409, for example. In addition, expressions involving logical references to clocks, timing signals, time reference calculators, and/or time references may also be used to specify synchronization of timing elements. For example, Boolean operands such as “AND,” “OR,” and “NOT”, along with other operands or types thereof, may be used to define such expressions or conditions.

Referring again to the flowchart of FIG. 6, the steps shown at block 604, diamond 606, and block 608 are discussed in the context of Presentation System 100.

During play of Presentation Content 120/played presentation 127, the states of declarative language instructions associated with a particular application 155 (such as content elements 302, timing elements 306, style elements 310, media object elements 312, event elements 360, and/or attributes (and optionally, attributes of the attributes) of each), are maintained within a structured representation of the application. One example of such a structured representation is a DOM. Structures and functions of DOMs are described by one or more specifications published by the W3C.

FIG. 7 is a diagram of a DOM 700. DOM 700 is a treelike hierarchy of nodes of several types, including a document node 702, which is the root node, element nodes 704, attribute nodes 706, and text nodes 708. Often, timing data structures are separate from content data structures in DOMs. The structure of DOM 700 is presented for illustrative purposes only. It will be understood that any element may have attributes or text, including attributes themselves.

When an application is loaded, its markup is loaded and parsed to create a DOM. As the application runs in the interactive environment, the user interacts with the application, events are fired, scripts are run, etc., various aspects of the environment, including state attributes, change which are reflected as modifications to the DOM. Accordingly, the DOM as originally loaded when an application is first started typically differs from the “live” DOM that is dynamically maintained during that application's lifetime.

DOM 700 (or portions thereof) may be periodically queried using XPATH queries or other types of queries (XQUERY, for example) to determine when attribute nodes (such as style attributes or display attributes) have particular values. In one implementation, XPATH queries determine when attribute nodes change values. As discussed above, attributes may have binary values, numeric values, string values, or other types of values. Attribute nodes (represented by nodes 704 and 706 in DOM 700, respectively) resolve to particular values as the interactive multimedia presentation plays and/or in response to events such as user events. In one implementation, XPATH queries resolve to true or false based on the queried values. In this manner, active time intervals for particular media objects may be formed, and XPATH may advantageously be used within timing structures to refer to and/or monitor information within content data structures. Queries may be performed concurrently on one or more attribute nodes, and expressions or conditions involving logical references to attributes may also be used to define queries. For example, Boolean operands such as “AND,” “OR,” and “NOT”, along with other operands or types thereof, may be used to define such expressions or conditions. In some instances, it may also be possible to skip some periodic querying. For example, based on the analysis of query results and/or other information, periods of time when query results will not change could be identified, and querying skipped during those periods.

XPATH queries may be performed on the DOM at a rate based on a timing signal such as timing signal 401or timing signal 471. It will be understood that timing signals 401 and 471 may be referred to directly or indirectly to establish times at which the DOM is queried. For example, timing signal 401 may be referred to indirectly via clock source 402, IC frame rate calculator 404, A/V frame rate calculator 406, application time 492, or page time 494. Likewise, timing signal 471 may be referred to indirectly via clock source 470, elapsed clip play time(s) 452, time reference calculator 454, media time reference 455, time reference calculator 408, or title time reference 409, for example. In addition, expressions involving logical references to clocks, timing signals, time reference calculators, and/or time references may also be used to define when queries are performed on the DOM. For example, Boolean operands such as “AND,” “OR,” and “NOT”, along with other operands or types thereof, may be used to define such expressions or conditions.

When particular actions are triggered by state changes detected via queries of the DOM, appropriate content is accessed and instructions relating to the actions are executed. For example, an external event-handler generally accesses event-related content and arranges for execution of instructions relating to the events. Work items (not shown) resulting from execution of instructions relating to triggered actions are placed in queue(s) (not shown), and are performed at a predetermined rate, such as the rate provided by IC frame rate 405. IC data 134 (for example, the rendering of particular media objects in accordance with user input) resulting from performance of work items is transmitted to mixer/renderer 110. Mixer/renderer 110 renders IC data 134 in the graphics plane to produce the interactive portion of played presentation 127 for the user.

Thus, an application provides certain declarative language instructions that specify states of a particular characteristic of a media object, and other declarative language instructions that specify actions (such as rendering of media objects, event generation, changes in variables, and other actions) associated with playing interactive content of an interactive multimedia presentation based on a state change of the characteristic. The actions associated with playing the interactive content may be conditionally triggered by periodically querying a structured representation of the application to detect the state changes. The XPATH function is well suited for querying DOMs to detect such state changes.

Accordingly, to provide the capability for graphics generated by applications to react to state changes in the interactive multimedia environment, the markup elements are arranged to include state attributes. Such state attributes are exposed to the applications through use of a DOM as described above. In an illustrative example, the state attributes include those shown in Table 2.

TABLE 2

| | Values | Initial | |
|---|---|---|---|
| Name | selected from: | Value | Rules for Setting Values |
| Foreground | True or False | False | True when an application is |
| | | | foremost; |
| | | | False otherwise |
| Focused | True or False | False | True after an activation gesture; |
| | | | False when another element |
| | | | changes to focused True or if a |
| | | | cancel gesture is received |
| Pointer | True or False | False | True when the cursor “hotspot” |
| | | | intersects the visible portion of |
| | | | an element; |
| | | | False otherwise (only occurs |
| | | | when the cursor is enabled) |
| Actioned | True or False | False | True during an activation |
| | | | gesture; |
| | | | False otherwise |
| Enabled | True or False | True | Always True unless modified |
| | | | by script |
| Value | See description | See | For button and area elements: |
| | | description | initially False, toggles at every |
| | | | activation of the element; |
| | | | For input element: initially a |
| | | | value set by the author; default |
| | | | value is an empty string if not |
| | | | specified in the markup DOM. |

Column 1 in Table 2 lists six state attributes. Column 2 lists the values the attributes can take. In this illustrative example, all the attributes except “value” are arranged to utilize Boolean values of True or False. The value attribute typically uses text or other non-Boolean information that is input from a user for its value.

The application author is able to set the initial values, as indicated in column 3, for state attributes. However, the values change based on user interaction through the receipt of gesture events that are described above. In particular, the state attributes of foreground, pointer, and actioned are changed by Presentation System 100 and will not be changed by markup or script. That is, actions of the Presentation System 100 override markup and script. However, the state attributes of focused, enabled, and value may be set by markup or script and the values so set will override the value that would otherwise be set by the Presentation System 100. And, in particular, script can override the state attributes of focused and enabled unless otherwise explicitly instructed through an “unset” instruction implemented through a script API to relinquish control back to an animation engine disposed in Presentation System 100. The rules governing the changing of attribute values thus establish a well defined order of control by establishing precedence and are summarized in the fourth column of Table 2.

Gesture events, in this illustrative example, are handled using markup processing. Other kinds of events are managed by script processing. The mapping of gesture events is handled in markup through style and timing expressions which are predicated on state properties described by the state attributes. Gesture events are handled by the Presentation System 100 by first converting the time of the gesture into an application time (e.g., application time reference 492) and then modifying the state properties of any affected elements in the DOM. While gesture events are handled by markup, they can still be propagated to script by setting up an appropriate event listener.

An example of how the method of FIG. 6 is usable in Presentation System 100 to present a particular media object 125 IC component 124/IC data 134 within played presentation 127 is provided. For discussion purposes, it is assumed that played presentation 127 is a high-definition DVD movie, the media object is a button graphic, and that interactivity is provided by an application 155 that presents the button graphic as a user-selectable item within menu 280 (shown in FIG. 2), concurrently with at least some portions of the movie.

The application includes a content element arranged as a button graphic called “Mybutton” which has the state attribute “focused.” The focused state attribute can assume the states of focused and not focused (i.e., true or false), based on gesture events of a user.

As shown in Table 2, the content elements, such as Mybutton, become focused after an activation gesture is received. Such activation gesture is received, for example, when a user manipulates a “hotspot” area of Mybutton my moving the tip of the cursor into a predefined area (called the “extent”) around the button graphic. Another way to create an activation gesture to change a content element state attribute to true using a keyboard, for example, to manipulate the content element to have focus.

When a content element is focused, it receives focus events such as user inputs (e.g., button pushes, selections, activations, text input, etc.) irregardless of its relative display order. This order, called “Z order” represents the layering of the graphics associated with content elements on a display. For a group of N graphical objects, a Z order=0 means that the graphic appears farthest away while a graphic having a Z order=N−1 appears on top of all the other graphics on the display. Thus, in many instances the focused content element will have a Z order=N−1 as it is the topmost object on the display and would be the one typically engaging in interaction with the user and receiving user events. However, a content element having a focused state attribute does not necessarily always have to have the highest Z order. In addition, at most one content element at a time has focus. In cases when a markup specifies more than one content element to have a state of focused, the lexically later element takes precedence. In this illustrative example, it is also possible to use style, animation or an XML application programming interface (“API”) to change the focused state of a content element.

Once a content element's state attribute is set to true that state is held. Thus, the content element is not focused (i.e., it focused attribute is false) in two cases: when the user selects a different content element to move to the focused state, for example by selecting another menu item from menu 280, and; when a pointer device moves into the extent of the element and a cancel gesture is received. After such cancel gesture, no content elements have a state attribute of focused.

As shown in Table 2, the actioned state is initially set to false. The actioned state changes to true at the start of an activation gesture which targets the content element and returns to false after the activation gesture ends. Such activation gesture is typically generated using a pointer device (e.g., a remote control or mouse) or with a keyboard. In the case of a pointer device, the activation gesture from the pointer device starts with a pointer-down event (such as a push of a mouse button) and lasts until a pointer-up event (such as the mouse button release). An activation gesture delivered by a keyboard has a duration of one tick.

It is further possible to change the actioned state of a content element using style, animation or an XML API to program instructions to simulate a user activation gesture on a content element. In both cases of actual or simulated activation gestures, actioned events are delivered to the single content element having a state attribute of focused equal true by changing the actioned state attribute of that element.

The pointer state of a content element is initially false. The value changes to true whenever the cursor hotspot intersects the content element. Otherwise the value is set to false. However, this behavior only occurs during those times when the cursor is enabled in an interactive media presentation. Thus, pointer move events are delivered to the single application containing the element which contains the pointer by changing the pointer state attribute to true. Such pointer move events are delivered irrespective of the application's Z order. Pointer click events are delivered to element in the application which contains the pointer regardless of whether it has focus. If the content element is able to receive focus, then this will occur as a result of the pointer click. If the content element is able to be actioned, then it will be actioned as result of the pointer click.

The foreground state attribute is set to true by the Presentation System 100 whenever an application is the front-most application in the Z order (i.e., it has the highest Z order). It is set to false whenever the application is located elsewhere in the Z order. Foreground events are delivered to the application when it gains or loses focus by changing the foreground state attribute to true.

The enabled state attribute is set to true by default. Actions of the Presentation System 100 will not change the enabled state attribute. However, style, animation or the XML API may change a content element's enabled state to false. When false, a content element is unable to receive focus.

Value events, such as those generated by a user inputting text to create a value, are delivered to the application containing the content element whose value changes by changing the value state attribute for the content element. Such events are delivered to the application regardless of Z order. The value state of a content element is able to be changed using style, animation or an XML API, and the value state is dependent upon the object type.

Input, area and button content elements are typically used to represent a user input object that responds to user events. An area content element behaves like a button in terms of activation but is definable in terms of shape and other parameters. The content elements associated with area an button are initially set with a value of false as shown in Table 2. The value toggles when the content element's actioned state attribute changes from to true.

The value of the value state attribute for an input or object content element is initialized to any desired value. The default is an empty string. The value state becomes editable, depending on the particular input device used, when there content elements' focus state changes from false to true.

Pseudo code illustrating declarative language instructions usable to conditionally trigger rendering of the media object associated with the content element, for example, MyButton, which has a state attribute called “focused” as described above, that may be either true or false based on a particular gesture event, is illustrated below:

```
<par begin = “id(‘MyButton’)[state:focused( )=true( )]” end =
  “id(‘MyButton’)[state:focused( )=false( )]”
    //run animation now because state focused is true
    //stop animation if the state changes to false
```

It can be seen that the “par” timing element sets forth the action of rendering the media object associated with the “Mybutton” element. The action is triggered (that is, the media object is rendered) when a query of a DOM node representing the focused attribute of the Mybutton element resolves to true, and the action is stopped (that is, the media object is not rendered) when a query of a DOM node representing the focused attribute of the Mybutton element resolves to false. Although in this example the renderable media object is the same media object that has the characteristic configured to assume a number of states, the renderable media object(s) may be different.

The process(es) illustrated in FIG. 6 may be implemented in one or more general, multi-purpose, or single-purpose processors, such as processor 802 discussed below in connection with FIG. 8. Unless specifically stated, the methods described herein are not constrained to a particular order or sequence. In addition, some of the described method or elements thereof can occur or be performed concurrently.

FIG. 8 is a block diagram of a general-purpose computing unit 800, illustrating certain functional components that may be used to implement, may be accessed by, or may be included in, various functional components of Presentation System 100. One or more components of computing unit 800 may be used to implement, be accessible by, or be included in, IC manager 104, presentation manager 106, and AVC manager 102. For example, one or more components of FIG. 8 may be packaged together or separately to implement functions of Presentation System 100 (in whole or in part) in a variety of ways.

A processor 802 is responsive to computer-readable media 804 and to computer programs 806. Processor 802, which may be a real or a virtual processor, controls functions of an electronic device by executing computer-executable instructions. Processor 802 may execute instructions at the assembly, compiled, or machine-level to perform a particular process. Such instructions may be created using source code or any other known computer program design tool.

Computer-readable media 804 represent any number and combination of local or remote devices, in any form, now known or later developed, capable of recording, storing, or transmitting computer-readable data, such as the instructions executable by processor 802. In particular, computer-readable media 804 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media 804 may also include transmission media and data associated therewith. Examples of transmission media/data include, but are not limited to, data embodied in any form of wireline or wireless transmission, such as packetized or non-packetized data carried by a modulated carrier signal.

Computer programs 806 represent any signal processing methods or stored instructions that electronically control predetermined operations on data. In general, computer programs 806 are computer-executable instructions implemented as software components according to well-known practices for component-based software development, and encoded in computer-readable media (such as computer-readable media 804). Computer programs may be combined or distributed in various ways.

Functions/components described in the context of Presentation System 100 are not limited to implementation by any specific embodiments of computer programs. Rather, functions are processes that convey or transform data, and may generally be implemented by, or executed in, hardware, software, firmware, or any combination thereof, located at, or accessed by, any combination of functional elements of Presentation System 100.

With continued reference to FIG. 8, FIG. 9 is a block diagram of an illustrative configuration of an operating environment 900 in which all or part of Presentation System 100 may be implemented or used. Operating environment 900 is generally indicative of a wide variety of general-purpose or special-purpose computing environments. Operating environment 900 is only one example of a suitable operating environment and is not intended to suggest any limitation as to the scope of use or functionality of the system(s) and methods described herein. For example, operating environment 900 may be a type of computer, such as a personal computer, a workstation, a server, a portable device, a laptop, a tablet, or any other type of electronic device, such as an optical media player or another type of media player, now known or later developed, or any aspect thereof. Operating environment 900 may also be a distributed computing network or a Web service, for example. A specific example of operating environment 900 is an environment, such as a DVD player or an operating system associated therewith, which facilitates playing high-definition DVD movies.

As shown, operating environment 900 includes or accesses components of computing unit 800, including processor 802, computer-readable media 804, and computer programs 806. Storage 904 includes additional or different computer-readable media associated specifically with operating environment 900, such as an optical disc, which is handled by optical disc drive 906. One or more internal buses 920, which are well-known and widely available elements, may be used to carry data, addresses, control signals and other information within, to, or from computing environment 900 or elements thereof.

Input interface(s) 908 provide input to computing environment 900. Input may be collected using any type of now known or later-developed interface, such as a user interface. User interfaces may be touch-input devices such as remote controls, displays, mice, pens, styluses, trackballs, keyboards, microphones, scanning devices, and all types of devices that are used input data.

Output interface(s) 910 provide output from computing environment 900. Examples of output interface(s) 910 include displays, printers, speakers, drives (such as optical disc drive 906 and other disc drives), and the like.

External communication interface(s) 912 are available to enhance the ability of computing environment 900 to receive information from, or to transmit information to, another entity via a communication medium such as a channel signal, a data signal, or a computer-readable medium. External communication interface(s) 912 may be, or may include, elements such as cable modems, data terminal equipment, media players, data storage devices, personal digital assistants, or any other device or component/combination thereof, along with associated network support devices and/or software or interfaces.

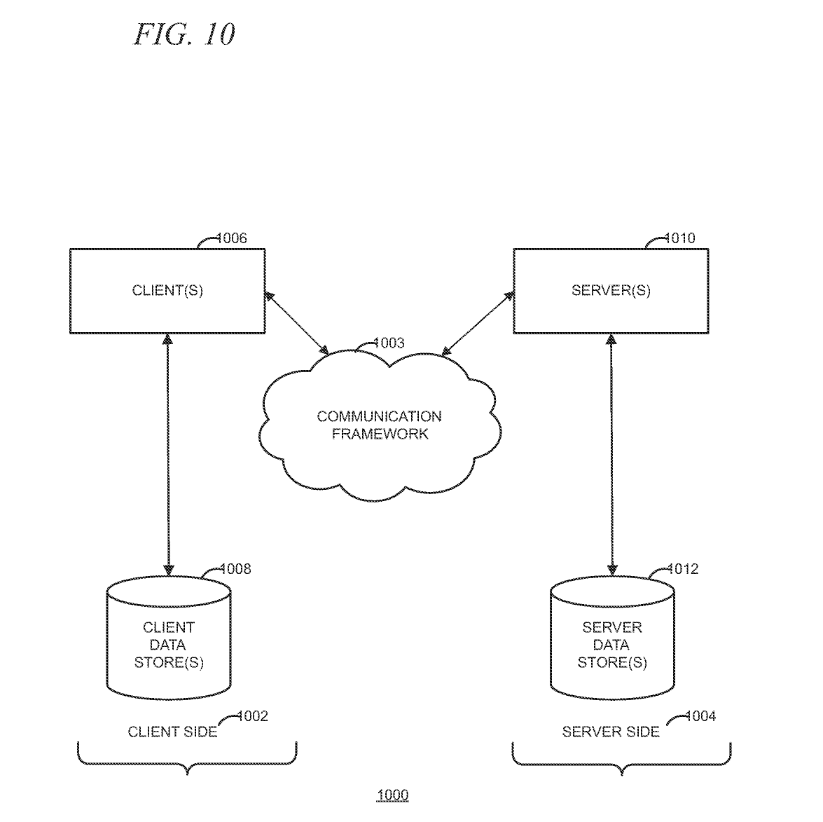

FIG. 10 is a simplified functional diagram of a client-server architecture 1000 in connection with which the Presentation System 100 or operating environment 900 may be used. One or more aspects of Presentation System 100 and/or operating environment 900 may be represented on a client-side 1002 of architecture 1000 or on a server-side 1004 of architecture 1000. As shown, communication framework 1003 (which may be any public or private network of any type, for example, wired or wireless) facilitates communication between client-side 1002 and server-side 1004.

On client-side 1002, one or more clients 1006, which may be implemented in hardware, software, firmware, or any combination thereof, are responsive to client data stores 1008. Client data stores 1008 may be computer-readable media 804, employed to store information local to clients 1006. On server-side 1004, one or more servers 1010 are responsive to server data stores 1012. Like client data stores 1008, server data stores 1012 may include one or more computer-readable media 804, employed to store information local to servers 1010.

Various aspects of an interactive multimedia presentation system that is used to present interactive content to a user synchronously with audio/video content have been described. An interactive multimedia presentation has been generally described as having a play duration, a variable play speed, a video component, and an IC component. It will be understood, however, that all of the foregoing components need not be used, nor must the components, when used, be present concurrently. Functions/components described in the context of Presentation System 100 as being computer programs are not limited to implementation by any specific embodiments of computer programs. Rather, functions are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “illustrative” is used herein to mean serving as an example, instance, or illustration. Any implementation or aspect thereof described herein as “illustrative” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A method for arranging an application to respond to state changes, the application comprising a markup component and at least one script component and providing one or more graphic elements that are synchronous with a video stream in an interactive multimedia environment, the method comprising the steps of:
in response to an event generated by a user, modifying at least one state attribute of a content element in the markup component;
parsing the markup component to create a document object model (“DOM”);
recursively introspecting the DOM to retrieve the at least one state attribute; and
triggering processing responsively to the recursive introspection to thereby respond to the state change.

2. The method of claim 1 in which the recursive introspection is performed using an XPATH query.

3. The method of claim 2 in which time in the interactive media environment is counted using a sequence of ticks and the XPATH query is performed at each tick.

4. The method of claim 1 in which the interactive media environment comprises a high definition DVD environment provided at least in part through use of an optical media selected from one of HD-DVD, Blu-Ray, Enhanced Versatile Disc, Digital Multilayer Disc, Holographic Versatile Disc, Versatile Multilayer Disc.

5. The method of claim 1 in which the at least one state attribute is selected from one of foreground, focused, pointer, actioned, enabled, or value.

6. The method of claim 5 in which each of the at least one state attributes, except value, is a Boolean attribute describable as being either true or false.

7. The method of claim 1 in which values of the state attributes are selected from one of binary values, numeric values, string values and predetermined sets of values.

8. The method of claim 1 in which the DOM is created from one or more XML documents.

9. The method of claim 1 in which the processing comprises consuming the event.

10. The method of claim 1 in which the processing comprises receiving the event by the at least one script component through use of an event listener.

11. The method of claim 1 in which the processing comprises manipulating the interactive multimedia environment through changes in the application's focus, Z order, or receipt of user events.

12. A machine-readable medium containing instructions which, when performed by one or more processors disposed in an electronic device, performs a method for handling user events in interactive multimedia environment, the method comprising the steps of:
processing an application in which at least a portion of an application is defined using a declarative description;
creating a runtime context for the application by generating a document object model (“DOM”) using the declarative description, the DOM comprising a plurality of state elements and providing an interface to the application to thereby enable modification to the declarative description;
responsively to a user event, modifying one or more state elements among the plurality of state elements in the DOM and
delivering the user event to the application through the interface according to the modified state elements.

13. The machine-readable medium of claim 12 in which the modifying of the one of more state elements comprises changing a state attribute of at least one state element in the plurality of state elements.

14. The machine-readable medium of claim 12 further including a step of propagating the user event to a script component of the application through an event element in the DOM.

15. The machine-readable medium of claim 12 in which the instructions comprise first and second instructions, the first instruction specifying an attribute associated with an XML content element and the second instruction comprising an XML timing element.

16. A machine-readable medium including software executed by at least one processor, the software comprising:
a presentation engine arranged for
a) decoding a declarative description of an application running in an interactive multimedia environment to thereby generate a document object model (“DOM”) comprising a plurality of nodes, and
b) querying the DOM to retrieve a state attribute from an element disposed in a node in the plurality of nodes;
an input event interface operatively coupled to the presentation engine for receiving an event associated with user interaction; and
a memory interface coupled to the presentation engine for addressing a memory arranged for storing the DOM.

17. The machine-readable medium of claim 16 in which the presentation engine is further arranged for modifying the DOM to reflect changes in the retrieved state attribute.

18. The machine-readable medium of claim 16 in which the query comprises an XPATH query that is performed periodically to examine nodes in the plurality of nodes in the DOM.

19. The machine-readable medium of claim 16 which the presentation engine is further arranged for delivering the received user event to the application in accordance with the retrieved state attribute.

20. The machine-readable medium of claim 16 which the presentation engine is further arranged for delivering the received user event to a content element generated from the decoded declarative description.
